(19) United States
(12) Patent Application Publication
(10) Pub. No.: US 2020/0143525 A1
(43) Pub. Date: May 7, 2020

(54) IMAGE PROCESSING METHOD, DEVICE AND COMPUTER READABLE STORAGE MEDIUM

(71) Applicant: SZ DJI TECHNOLOGY CO., LTD., Shenzhen (CN)

(72) Inventor: Pan HU, Shenzhen (CN)

(21) Appl. No.: 16/731,026

(22) Filed: Dec. 30, 2019

Related U.S. Application Data
(63) Continuation of application No. PCT/CN2017/096627, filed on Aug. 9, 2017.

(51) Int. Cl. G06T 5/00; G06T 7/00; G06T 7/90; G06T 3/40; G06T 9/00; G06F 17/18

(52) U.S. Cl. CPC G06T 5/009; G06T 7/0002; G06T 7/90; G06T 2207/10024; G06T 9/00; G06F 17/18; G06T 2207/20076; G06T 3/40

(57) ABSTRACT

An image processing method includes pre-processing an original image to obtain a pre-processed image, decomposing the pre-processed image to obtain a plurality of first sub-images; determining detail information, color information, and mean value information of the first sub-images, compressing the plurality of first sub-images to obtain a plurality of second sub-images according to the detail information, the color information, and the mean value information, and determining a target image according to the plurality of the second sub-images.

### CROSS-REFERENCE TO RELATED APPLICATION

This application is a continuation of International Application No. PCT/CN2017/096627, filed Aug. 9, 2017, the entire content of which is incorporated herein by reference.

### TECHNICAL FIELD

The present disclosure relates to unmanned aerial vehicle field and, more particularly, to an image processing method, a device, and a computer-readable storage medium.

### BACKGROUND

A dynamic range of an image refers to the ratio of the highest brightness value to the lowest brightness value in a natural scene. With the development of sensor technologies, current cameras can obtain up to 16 bits of data, but most display devices can only display 8 bits of data. When a high dynamic range image needs to be displayed on a low dynamic range display device, tone mapping of the high dynamic range image is required.

In the existing technology, a method for performing tone mapping on a high dynamic range image includes a global tone mapping method and a local tone mapping method, however, both the global tone mapping method and the local tone mapping method perform tone mapping on the luminance information of the high dynamic range image, which lead to a difficulty in retaining the color information of the high dynamic range image in the low dynamic range image after tone mapping, and a offset in color in the low dynamic range image compared to the high dynamic range image.

### SUMMARY

In accordance with the disclosure, there is provided an image processing method including pre-processing an original image to obtain a pre-processed image, decomposing the pre-processed image to obtain a plurality of first sub-images, determining detail information, color information, and mean value information of the plurality of first sub-images, compressing the plurality of first sub-images to obtain a plurality of second sub-images according to the detail information, the color information, and the mean value information, and determining a target image according to the plurality of second sub-images.

In accordance with the disclosure, there is provided an image processing device including a computer-readable storage medium storing a computer program, and one or more processors individually or collectively configured to pre-process an original image to obtain a pre-processed image, decompose the pre-processed image into a plurality of first sub-images, determine detail information, color information, and mean value information of the first sub-images, compress the plurality of first sub-images according to the detail information, the color information, and the mean value information to generate a plurality of second sub-images, and determine a target image according to the plurality of second sub-images.

### BRIEF DESCRIPTION OF THE DRAWINGS

FIG. 1 is a flowchart of an image processing method according to an embodiment of the disclosure.

FIG. 2 is a schematic diagram showing an image processing method according to an embodiment of the disclosure.

FIG. 3 is a flowchart of an image processing method according to another embodiment of the disclosure.

FIG. 4 is a flowchart of an image processing method according to another embodiment of the disclosure.

FIG. 5 is a flowchart of an image processing method according to another embodiment of the disclosure.

FIG. 6 is a flowchart of an image processing method according to another embodiment of the disclosure.

FIG. 7 is a structure diagram of an image processing device according to an embodiment of the disclosure.

FIG. 8 is a structure diagram of a UAV according to an embodiment of the disclosure.

### REFERENCE NUMERALS

| | | |
|---|---|---|
| 20-first image | 21-first sub-image | 22-first sub-image |
| 23-first sub-image | 24-first sub-image | 210-second sub-image |
| 220-second sub-image | 230-second sub-image | 240-second sub-image |
| 200-third image | 60-mean value | 61-detail information |
| 62-mean value information | 63-block reconstruction | 64-color information |
| 65-detail information | 66-block reconstruction | 70-image processing device |
| 71-one or more processors | 100-unmanned aerial vehicle | |
| 107-electrical motor | 106-propeller | 117-electronic governor |
| 118-flight controller | 108-sensor system | 110-communication system |
| 102-carrier | 104-photographing device | 112-ground station |
| 114-antenna | 116-electromagnetic wave | |
| 109-image processing device | | |

### DETAILED DESCRIPTION OF THE EMBODIMENTS

Technical solutions of the present disclosure will be described with reference to the drawings of the embodiments of the disclosure. The described embodiments are only some embodiments of the disclosure not all the embodiments. Based on the embodiments of the disclosure, all other embodiments obtained by one of ordinary skill in the art without any creative effort are within the scope of the present disclosure.

When a component is referred to as “fixed to” another component, the component may be directly on the another component or may have a component therebetween. When a component is referred to as “connected to” another component, the component may be directly connected to the another component or may have a component therebetween.

All technical and scientific terms used herein have the same meaning as commonly understood by one of ordinary skill in the art, unless otherwise defined. The terminology used in the specification of the present disclosure is for the purpose of describing specific embodiments and is not intended to limit the disclosure. The term “and/or” as used herein includes any and all combinations of one or more of the associated listed items.

Some embodiments of the disclosure are described in detail with reference to the drawings. When no conflict, the features of the embodiments and the embodiments described below can be combined with each other.

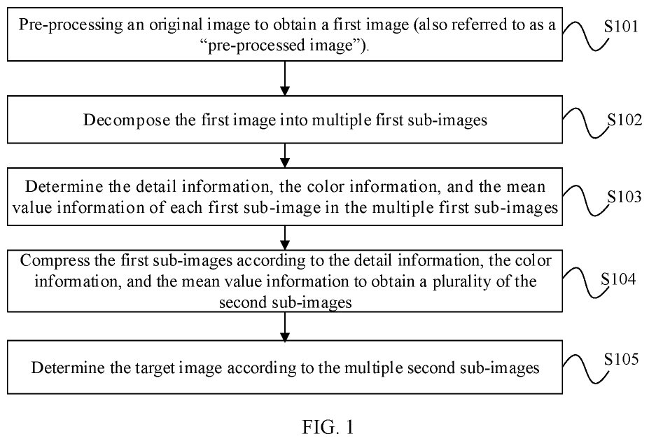

In accordance with the disclosure, there is provided an image processing method. FIG. 1 is a flowchart of an example image processing method consistent with embodiments of the disclosure. The method can be implemented by, e.g., an image processing device, which can be arranged at an unmanned aerial vehicle (UAV) or at a ground station. The ground station may be a remote controller, a smart phone, a tablet computer, a ground control station, a laptop computer, a watch, a wristband, or a combination thereof. In other embodiments, the image processing device may be arranged at a photographing device, such as a handheld gimbal, a digital camera, a video camera, etc. If the image processing device is arranged at the UAV, the image processing device can process the images photographed by the photographing device carried by the UAV. If the image processing device is arranged at the ground station, the ground station can receive the image data transferred wirelessly by the UAV, and the image processing device processes the image data received by the ground station. The user holds the photographing device, and the image processing device of the photographing device processes the image captured by the photographing device. In the embodiments, the application scenarios are not restricted. The image processing method is described in detail below.

As shown in FIG. 1, at S101, an original image is pre-processed to obtain a first image (also referred to as a “pre-processed image”).

In the embodiment, an image processing device first pre-processes an original image to obtain a first image. The original image is an image that needs image processing. In some embodiments, the original image may be an individual image frame captured by a photographing device, and may be one image frame of a plurality of continuous image frames in video data captured by a photographing device. In the embodiment, the source of the original image is not restricted.

In some embodiments, obtaining the first image by pre-processing the original image includes converting the original image into red, green, and blue (RGB) space (i.e., converting the original image from an original color space into RGB space) to obtain a second image (also referred to as an “RGB image”), and globally adjusting the second image to obtain the first image. The first image includes R channel data, G channel data, and B channel data.

In the embodiment, the original image is denoted as L, which is converted into the RGB space to obtain the second image. In some embodiments, the original image is a high dynamic range image and the second image obtained by converting the original image into the RGB space is also a high dynamic range image. The second image is denoted as Lᵢ, i∈r, g, b, where Lᵣ denotes the R channel data of the second image, L_{g} denotes the G channel data of the second image, and L_{b} denotes the B channel data of the second image. The second image Lᵢ is globally adjusted to obtain the first image, and the first image is denoted as Lᵢ′, i∈r, g, b. The global adjustment method can include obtaining the first image Lᵢ′, i∈r, g, b by global adjustment of the high dynamic range image, i.e., the second image Lᵢ, using a log curve. The specific adjustment method is shown in formula (1):

Lᵢ′=log(Lᵢ*10⁶+1) (1)

where, i∈r, g, b, Lᵣ denotes the R channel data of the second image before the global adjustment, L_{g} denotes the G channel data of the second image before the global adjustment, L_{b} denotes the B channel data of the second image before the global adjustment, Lᵣ′ denotes the R channel data of the first image after the global adjustment, T_{g}′ denotes the G channel data of the first image after the global adjustment, and L_{b}′ denotes the B channel data of the first image after the global adjustment.

At S102, the first image is decomposed into multiple first sub-images.

In some embodiments, the first image Lᵢ′, i∈r, g, b is decomposed into the plurality of first sub-images. A first sub-image is denoted as Xᵢ, i∈r, g, b, where xᵣ denotes the R channel data of the first sub-image, X_{g} denotes the G channel data of the first sub-image, and X_{b} denotes the B channel data of the first sub-image. In some embodiments, the first image Lᵢ′, i∈r, g, b is decomposed into the plurality of first sub-images by a sliding window method. The mean value mᵣ of the first sub-images in R channel can be calculated according to the R channel data xᵣ of the first sub-images, the mean value m_{g} of the first sub-images in the G channel can be calculated according to the G channel data X_{g} of the first sub-images, and the mean value m_{b} of the first sub-images in the B channel can be calculated according to the B channel data X_{b} of the first sub-images. The mean values of the first sub-images in R channel, G channel, and B channel are denoted as mᵢ, i∈r, g, b. The overall mean value of the first sub-images in the three channels of R channel, G channel, and B channel is denoted as m, and m can be determined by using following formula (2):

m=(mᵣ+m_{g}+m_{b})/3 (2)

At S103, detail information, color information, and mean value information of each first sub-image of the plurality of first sub-images are determined.

In the embodiment, each first sub-image of the plurality of first sub-images can be decomposed into 3 parts, and the 3 parts are detail part, color part, and mean value part. The detail part corresponds to the detail information of the first sub-images, the color part corresponds to the color information of the first sub-images, and the mean value part corresponds to the mean value information of the first sub-images. The detail information can be expressed as formula (3), the color information can be expressed as formula (4), and the mean value information is the overall mean value m of the first sub-images in three channels of the R channel, G channel, and B channel.

X̅ᵢ̅=Xᵢ−mᵢ,i∈r,g,b (3)

where X̅ᵣ̅ denotes the detail information of the first sub-images in R channel, X̅_̅{̅g̅}̅ denotes the detail information of the first sub-images in G channel, and X̅_̅{̅b̅}̅ denotes the detail information of the first sub-images in B channel.

m̅ᵢ̅=mᵢ−m,i∈r,g,b (4)

where m̅ᵣ̅ denotes the color information of the first sub-images in R channel, m̅_̅{̅g̅}̅ denotes the color information of the first sub-images in G channel, and m̅_̅{̅b̅}̅ denotes the color information of the first sub-images in B channel.

At S104, the first sub-images are compressed according to the detail information, the color information, and the mean value information to obtain the plurality of second sub-images.

In some embodiments, each of the first sub-images is compressed according to detail information X̅ᵢ̅, color information m̅ᵢ̅, and mean value information m of the first sub-image to obtain a second sub-image corresponding to the first sub-image, i.e., the plurality of second sub-images are generated by compressing the plurality of first sub-images.

In some embodiments, compressing the plurality of first sub-images according to the detail information, the color information, and the mean value information to generate the plurality of second sub-images includes non-linearly compressing the color information and the detail information of each first sub-image and linearly compressing the mean value information of the first sub-image to obtain the corresponding second sub-image.

Specifically, when any one of the first sub-images is compressed, the color information and detail information of the first sub-image can be non-linearly compressed, and the mean value information of the first sub-image can be linearly compressed, so that the corresponding second sub-image of the first sub-image is obtained. In general, each first sub-image can be compressed in the same way so that the second sub-image corresponding to that first sub-image is obtained, i.e., the plurality of second sub-images are generated.

At S105, the target image is determined according to the plurality of second sub-images.

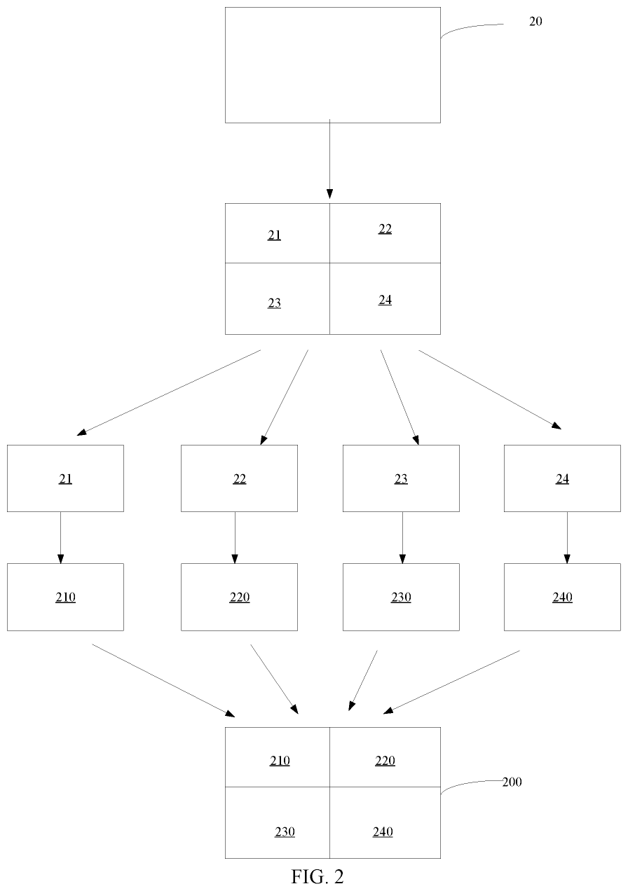

As shown in FIG. 2, reference numeral 20 indicates the first image. According to S102, the first image is decomposed into the plurality of first sub-images, such as the first sub-image 21, the first sub-image 22, the first sub-image 23, and the first sub-image 24. This is only a schematic illustration and does not limit the specific number of the first sub-images. According to S103, the detail information, the color information, and the mean value information of the first sub-image 21, the detail information, the color information, and the mean value information of the first sub-image 22, the detail information, the color information, and the mean value information of the first sub-image 23, and the detail information, the color information, and the mean value information of the first sub-image 24 are determined. According to S104, the first sub-image 21 is compressed to obtain the second sub-image 210 according to the detail information, color information, and the mean value information of the first sub-image 21, the first sub-image 22 is compressed to obtain the second sub-image 220 according to the detail information, color information, and the mean value information of the first sub-image 22, the first sub-image 23 is compressed to obtain the second sub-image 230 according to the detail information, color information, and the mean value information of the first sub-image 23, and the first sub-image 24 is compressed to obtain the second sub-image 240 according to the detail information, color information, and the mean value information of the first sub-image 24.

Determining the target image according to the plurality of second sub-images includes forming a third image by arranging the second sub-images corresponding to the first sub-images according to the positions of the first sub-images in the first image, and mapping the pixel value of each pixel in the third image to the dynamic range of a display device to obtain the target image. In this disclosure, the third image is also referred to as a “composed image.”

As shown in FIG. 2, the first sub-image 21 is at the top left corner of the first image 20, the first sub-image 22 is at the top right corner in the first image 20, the first sub-image 23 is at the bottom left corner in the first image 20, and the first sub-image 24 is at the bottom right corner in the first image 20. The second sub-image 210, the second sub-image 220, the second sub-image 230, and the second sub-image 240 are arranged to form the third image 200 according to the positions of the first sub-image 21, the first sub-image 22, the first sub-image 23, and the first sub-image 24 in the first image. In some embodiments, the position of the second sub-image 210 in the third image 200 is the same as the position of the first sub-image 21 in the first image 20, the position of the second sub-image 220 in the third image 200 is the same as the position of the first sub-image 22 in the first image 20, the position of the second sub-image 230 in the third image 200 is the same as the position of the first sub-image 23 in the first image 20, and the position of the second sub-image 240 in the third image 200 is the same as the position of the first sub-image 21 in the first image 20. In some embodiments, the third image 200 formed by the second sub-image 210, the second sub-image 220, the second sub-image 230, and the second sub-image 240 is a low dynamic range image, and the pixel value of each pixel in the third image 200 is from 0 to 1. That is, compressing the plurality of first sub-images are compressed to generate the plurality of second sub-images according to the detail information, the color information, and the mean value information can be equivalent to normalizing the pixel value of each pixel in the first sub-images to obtain the second sub-images with pixel values from 0 to 1.

After the third image 200 is obtained, the pixel value of each pixel in the third image 200 can be mapped to the dynamic range of the display device. For example, the dynamic range of the display device is 8 bit, thus the pixel value of each pixel in the third image 200 can be stretched to the range of 0-255 to obtain the target image. That is, the pixel values in the range 0-1 are mapped to the range 0-255.

In the embodiment, the original image is a high dynamic range image and the target image is a low dynamic range image.

In some other embodiments, before mapping the pixel value of each pixel in the third image to the dynamic range of the display device, the process also includes adjusting the pixel values of the pixels in the third image to improve the contrast of the third image.

Since the pixel value of each pixel in the third image 200 is from 0 to 1, the pixel values of the pixels in the third image 200 can be adjusted to improve the contrast of the third image 200. The specific adjustment method can include compressing the pixel values of the brightest and the darkest pixels according to a pre-set compression ratio. For example, the pre-set ratio can be 10%. Since the pixel value of each pixel in the third image 200 is 1 at maximum, the pixels with the pixel values smaller than 1*10% is set to 0 and the pixels with the pixel values larger than 1*(1−10%) is set to 1.

In some embodiments, after the third image 200 is formed by arranging the second sub-image 210, the second sub-image 220, the second sub-image 230, and the second sub-image 240, weighting process is performed on the second sub-image 210, the second sub-image 220, the second sub-image 230, and the second sub-image 240. The reason for performing the weighting process is that the sliding window method is used to decompose the first image into a plurality of first sub-images. In certain sliding window method, adjacent first sub-images may overlap with each other. That is, two adjacent ones of the first sub-image 21, the first sub-image 22, the first sub-image 23, and the first sub-image 24 may overlap with each other. After the first sub-image 21, the first sub-image 22, the first sub-image 23, and the first sub-image 24 are compressed individually to obtain the second sub-image 210, the second sub-image 220, the second sub-image 230, and the second sub-image 240, the overlaps may still exist between two adjacent ones of the second sub-image 210, the second sub-image 220, the second sub-image 230, and the second sub-image 240. To prevent the overlaps from affecting the picture quality of the third image 200, the weighting process is implemented on the second sub-image 210, the second sub-image 220, the second sub-image 230, and the second sub-image 240 in the third image 200 to reduce or eliminate the overlaps between the two adjacent second sub-images.

In the embodiment, the first image is obtained by pre-processing the original image and the first image is decomposed into the plurality of first sub-images. Each first sub-image is compressed to generate a corresponding second sub-image according to the detail information, the color information, and the mean value information of the first sub-image and the target image is determined according to the plurality of second sub-images. When the tone mapping is performed on the high dynamic range image, not only tone mapping is performed on the brightness information, but also the detail information, the color information, and the mean value information are compressed at the same time to ensure that the low dynamic range image retains the color information of the high dynamic range image after tone mapping and to avoid the offset in color of the low dynamic range image as compared to the high dynamic range image.

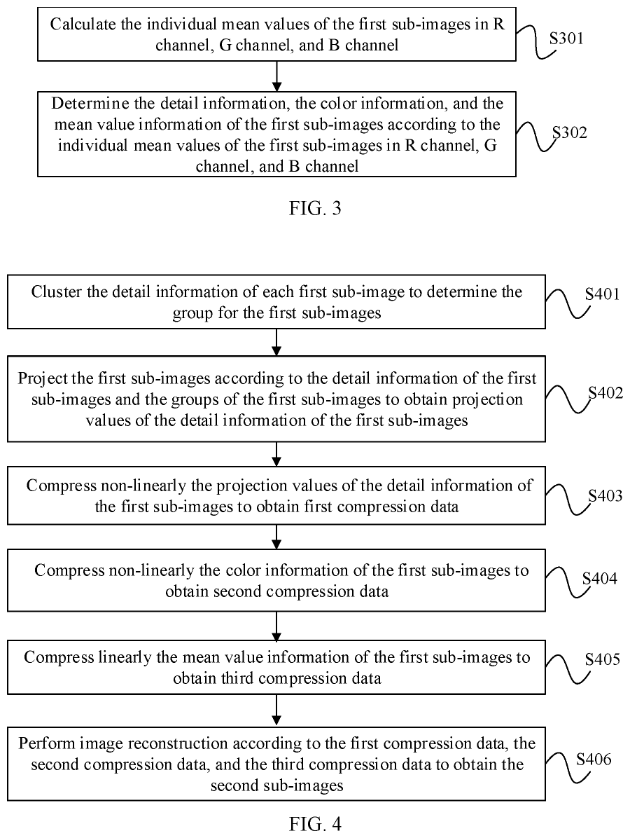

In accordance with the disclosure, there is provided an image processing method. FIG. 3 is a flowchart of an example image processing method consistent with the embodiments of the disclosure. As shown in FIG. 3, determining the detail information, the color information, and the mean value information of the first sub-images (S103 in FIG. 1) includes the following processes.

At S301, the individual mean values of the first sub-images in R channel, G channel, and B channel are calculated.

In some embodiments, calculating the individual mean values of the first sub-images in R channel, G channel, and B channel includes calculating a first mean value of the first sub-images in R channel according to the R channel data of the first sub-images, calculating a second mean value of the first sub-images in G channel according to the G channel data of the first sub-images, and calculating a third mean value of the first sub-images in B channel according to the B channel data of the first sub-images.

The first sub-images are denoted as Xᵢ, i∈r, g, b, where xᵣ denotes the R channel data of the first sub-images, X_{g} denotes the G channel data of the first sub-images, and X_{b} denotes the B channel data of the first sub-images. When the individual mean values of the first sub-images in R channel, G channel, and B channel are calculated, in some embodiments, the first mean value mᵣ of the first sub-images in R channel is calculated according to the R channel data xᵣ of the first sub-images, the second mean value m_{g} of the first sub-images in G channel is calculated according to the G channel data X_{g} of the first sub-images, and the third mean value m_{b} of the first sub-images in B channel is calculated according to the B channel data X_{b} of the first sub-images.

At S302, the detail information, the color information, and the mean value information of the first sub-images are determined according to the individual mean values of the first sub-images in R channel, G channel, and B channel.

In some embodiments, determining the detail information, the color information, and the mean value information of the first sub-images according to the individual mean values of the first sub-images in R channel, G channel, and B channel includes the following aspects.

In one aspect, the detail information of the first sub-images in R channel, G channel, and B channel is determined according to the R channel data, the G channel data, and the B channel data of the first sub-images and the individual mean values of the first sub-images in R channel, G channel, and B channel.

In some embodiments, determining the detail information of the first sub-images in R channel, G channel, and B channel according to the R channel data, the G channel data, and the B channel data of the first sub-images and the individual mean values of the first sub-images in R channel, G channel, and B channel includes determining the detail information of the first sub-images in R channel according to the R channel data and the first mean value of the first sub-images, determining the detail information of the first sub-images in G channel according to the G channel data and the second mean value of the first sub-images, and determining the detail information of the first sub-images in B channel according to the B channel data and the third mean value of the first sub-images.

For example, the R channel data of the first sub-images is denoted as xᵣ, the first mean value is denoted as mᵣ, the detail information of the first sub-images in the R channel is denoted as X̅ᵣ̅, X̅ᵣ̅=Xᵣ−mᵣ. The G channel data of the first sub-images is denoted as X_{g} , the first mean value is m_{g}, the detail information of the first sub-images in the G channel is denoted as X̅_̅{̅g̅}̅, X̅_̅{̅g̅}̅=X_{g}−m_{g}. The B channel data of the first sub-images is denoted as X_{b}, the first mean value is denoted as m_{b}, the detail information of the first sub-images in the B channel is denoted as X̅_̅{̅b̅}̅, X̅_̅{̅b̅}̅=X_{b}−m_{b}.

In another aspect, the color information of the first sub-images in each channel is determined according to the individual mean values of the first sub-images in R channel, G channel, and B channel and the mean value of the first sub-images.

In some embodiments, determining the color information of the first sub-images in R channel, G channel, and B channel according to the individual mean values of the first sub-images in R channel, G channel, and B channel and the mean value of the first sub-images includes determining the color information of the first sub-images in R channel according to the first mean value and the mean value of the first sub-images, determining the color information of the first sub-images in G channel according to the second mean value and the mean value of the first sub-images, and determining the color information of the first sub-images in B channel according to the third mean value and the mean value of the first sub-images.

In some embodiments, the mean value information of the first sub-images is a mean value of the first mean value, the second mean value, and the third mean value. In some embodiments, the individual mean values of the first sub-images in R channel, G channel, and B channel are denoted as mᵢ, i∈r, g, b. The overall mean value of the first sub-images in R channel, G channel, and B channel is denoted as m, m can be determined according to formula (2) above, i.e., m=(mᵣ+m_{g}+m_{b})/3. The mean value of the first sub-images is the mean value of the first mean value, the second mean value, and the third mean value, i.e., the mean value of the first sub-images is m.

For example, the first mean value is denoted as mᵣ, the mean value information of the first sub-images is denoted as m, the color information of the first sub-images in R channel is denoted as m̅ᵣ̅, m̅ᵣ̅=mᵣ−m. The second mean value is denoted as m_{g}, the mean value information of the first sub-images is denoted as m, the color information of the first sub-images in G channel is denoted as m̅_̅{̅g̅}̅, m̅_̅{̅g̅}̅=m_{g}−m. The third mean value is denoted as m_{b}, the mean value information of the first sub-images is m, the color information of the first sub-images in B channel is denoted as m̅_̅{̅b̅}̅, m̅_̅{̅b̅}̅=m_{b}−m.

In the embodiment, by calculating the individual mean values of the first sub-images in R channel, G channel, and B channel, the detail information, the color information, and the mean value information of the first sub-images are determined, and accurate calculations are implemented for the detail information, the color information, and the mean value information.

In accordance with the disclosure, there is provided an image processing method. FIG. 4 is a flowchart of an example image processing method consistent with embodiments of the disclosure. As shown in FIG. 4, based on the embodiments descried above in connection with FIG. 1, obtaining the second sub-images by non-linearly compressing the color information and the detail information of each first sub-image and linearly compressing the mean value information of each first sub-image includes the following processes.

At S401, the detail information of the first sub-images is clustered to determine a group to which each first sub-image belongs.

As shown in FIG. 2, the first image 20 is decomposed into the plurality of first sub-images, and the detail information of each first sub-image can be denoted as X̅ᵢ̅=Xᵢ−mᵢ, i∈r,g,b, where X̅ᵣ̅ denotes the detail information of the first sub-image in R channel, X̅_̅{̅g̅}̅ denotes the detail information of the first sub-images in G channel, and X̅_̅{̅b̅}̅ denotes the detail information of the first sub-images in B channel.

In the embodiment, by clustering the detail information of the first sub-images, the group of each first sub-image is determined. In some embodiments, the K-means method can be used for clustering. During clustering, the detail information of each first sub-image can be constructed as a column vector. For example, a first sub-image Xᵢ, i∈r, g, b is a 5*5 block, and hence each of xᵣ, X_{g}, X_{b} is a 5*5 block and each of X̅ᵣ̅, X̅_̅{̅g̅}̅, X̅_̅{̅b̅}̅ is a 5*5 block. Each element of X̅ᵣ̅ can be constructed as a column vector, which is a 25*1 column vector. Similarly, each element of X̅_̅{̅g̅}̅ can be constructed as a column vector, which is a 25*1 column vector, and each element of X̅_̅{̅b̅}̅ can be constructed as a column vector, which is a 25*1 column vector. The column vectors corresponding to X̅ᵣ̅, X̅_̅{̅g̅}̅, and X̅_̅{̅b̅}̅ form a column vector of 75*1. The detail information of each first sub-image can form a column vector of 75*1. As shown in FIG. 2, the detail information of the first sub-image 21 can form a column vector, the detail information of the first sub-image 22 can form a column vector, the detail information of the first sub-image 23 can form a column vector, and the detail information of the first sub-image 24 can form a column vector. The column vectors corresponding to the first sub-images are clustered using K-means clustering method. For example, the column vector corresponding to each first sub-image is a column vector of 75*1, then the dimension of a cluster object is 75*1. With clustering, a plurality of column vectors can be divided into several groups. The number of groups after clustering is less than or equal to the number of the clustering objects, i.e., the column vectors. The group to which a column vector belongs is the group to which the corresponding first sub-image belongs. That is, in the embodiment, the first sub-images are clustered by clustering the column vectors formed by the detail information of the first sub-images.

Assume that the first image is decomposed into M first sub-images, and N groups are obtained after clustering, where M and N are positive integers and N is less than or equal to M. The N groups are respectively denoted as G₁, G₂, G₃ . . . G_{N}, and the covariance matrices of the groups are Φ₁, Φ₂, Φ₃ . . . . Φ_{N}, where Φₙ denotes the covariance matrix of the n^{th} group in the N groups. Formula (5) can be obtained with eigenvalue decomposition of the covariance matrix Φₙ:

Φₙ=QₙΛₙQₙ⁻¹ (5)

where Qₙ is a square matrix composed of eigenvectors, and Λₙ is a diagonal matrix composed of eigenvalues. Correspondingly, the dictionary Pₙ corresponding to the n^{th} group can be calculated as follows in formula (6):

Pₙ=Qₙ^{T} (6)

where Qₙ^{T} is the transpose matrix of Qₙ.

Dictionaries corresponding to other ones of the N groups other than the n^{th} group can be calculated using the same method as above. Thus, the corresponding dictionaries for groups G₁, G₂, G₃ . . . G_{N} are P₁, P₂, P₃ . . . P_{N}, respectively.

At S402, the first sub-images are projected according to the detail information of the first sub-images and the groups of the first sub-images to obtain projection values of the detail information of the first sub-images.

In some embodiments, projecting the first sub-images according to the groups of the first sub-images and the detail information of the first sub-images includes determining the covariance matrices of the groups of the first sub-images, decomposing the covariance matrices to determine the corresponding dictionaries of the groups for the first sub-images, and projecting the detail information of the first sub-images into the corresponding dictionaries of the groups of the first sub-images.

As shown in FIG. 2, the first sub-image 21, the first sub-image 22, the first sub-image 23, and the first sub-image 24 are first clustered using the clustering method above. For example, assume 3 groups are obtained after clustering, which are G₁, G₂, G₃. Assume the first sub-image 21 belongs to the first group G₁, the first sub-image 22 and the first sub-image 23 belong to the second group G₂, and the first sub-image 24 belongs to the third group G₃. If the covariance matrices of the three groups are Φ₁, Φ₂, Φ₃, respectively. The corresponding dictionary P₁ of G₁, the corresponding dictionary P₂ of G₂, and the corresponding dictionary P₃ of G₃ can be calculated according to the formulas (5) and (6).

In some embodiments, the detail information of each first sub-image is projected into the corresponding dictionary of the group that the first sub-image belongs to. For example, the detail information of the first sub-image 21 is projected into the corresponding dictionary of the group to which the first sub-image 21 belongs, the detail information of the first sub-image 22 is projected into the corresponding dictionary of the group to which the first sub-image 22 belongs, the detail information of the first sub-image 23 is projected into the corresponding dictionary of the group to which the first sub-image 23 belongs, and the detail information of the first sub-image 24 is projected into the corresponding dictionary of the group to which the first sub-image 24 belongs. The projection process will be described in more detail taking the projection of the detail information of the first sub-image 21 into the corresponding dictionary of the group to which the first sub-image 21 belongs as an example. The projection processes for other first sub-images are similar.

In some embodiments, the detail information of the first sub-image 21 is X̅ᵢ̅, and the corresponding dictionary of the group to which the first sub-image 21 belongs is P₁. A projection value P₁X̅ᵢ̅ is obtained by projecting the detail information of the first sub-image 21 into the corresponding dictionary of the group to which the first sub-image 21 belongs.

At S403, the projection values of the detail information of the first sub-images are non-linearly compressed to obtain first compression data.

In some embodiments, the projection value P₁X̅ᵢ̅ is adjusted with a S-type curve, and the projection value after adjustment is denoted as α. The relationship between α and P₁X̅ᵢ̅ can be determined by formula (7):

α=w₁(γ(P₁X̅ᵢ̅)) (7)

where w₁ denotes the S-type curve, γ denotes a threshold function. For an unknown number z, the threshold function γ can be expressed as formula (8) below, and the S-type curve can be expressed as formula (9) below:

$$γ ( z ) = \{ \begin{matrix}z , z > TN * max \\ 0 , else\end{matrix} \qquad ( 8 )$$

where max denotes the maximum value of the projection value, TN denotes a threshold.

w₁(z)=(2/π)*arctan(z*b) (9)

where b is a parameter used to control a shape of the S-type curve.

The first compression data obtained by non-linearly compressing the projection value P₁X̅ᵢ̅ of the detail information X̅ᵢ̅ of the first sub-image 21 can be P₁^{T}α, α=w₁(γ(P₁X̅ᵢ̅)).

At S404, the color information of the first sub-images is non-linearly compressed to obtain second compression data.

The color information m̅ᵢ̅=mᵢ−m,i∈r,g,b of the first sub-image 21 can be non-linearly compressed using a S-type curve to obtain the second compression data w₃(m̅ᵢ̅), where the function type of w₃ is the same as the function type of w₁.

At S405, the mean value information of the first sub-images is linearly compressed to obtain third compression data.

The mean value information of the first sub-image 21 is the overall mean value of the first sub-image 21 in R channel, G channel, and B channel, and the third compression data obtained by linearly compressing the mean value information of the first sub-image 21 is denoted as w₂*m, where w₁ is a number from 0 to 1.

At S406, image reconstruction is performed according to the first compression data, the second compression data, and the third compression data to obtain the second sub-images.

Image reconstruction is performed according to the first compression data P₁^{T}α, the second compression data w₃(m̅ᵢ̅), and the third compression data w₂*m of the first sub-image 21 to obtain the second sub-image 210, which can be denoted as yᵢ, where yᵢ can be determined by formula (10):

yᵢ=P₁^{T}α+w₂*m+w₃(m̅ᵢ̅) (10)

The calculation principles of the second sub-image 220, the second sub-image 230, and the second sub-image 240 are the same as the calculation principles of the second sub-image 210, which are not described here.

In the embodiment, the first image is obtained by pre-processing the original image and the first image is decomposed into the plurality of first sub-images. The first sub-images are compressed to generate the plurality of second sub-images according to the detail information, the color information, and the mean value information of the first sub-images. The target image is determined according to the plurality of second sub-images. When tone mapping is performed on the high dynamic range image, not only tone mapping is performed on the brightness information, but also the detail information, the color information, and the mean value information are compressed at the same time, so as to ensure that the low dynamic range image retains the color information of the high dynamic range image after tone mapping and to avoid an offset in color of the low dynamic range image as compared to the high dynamic range image.

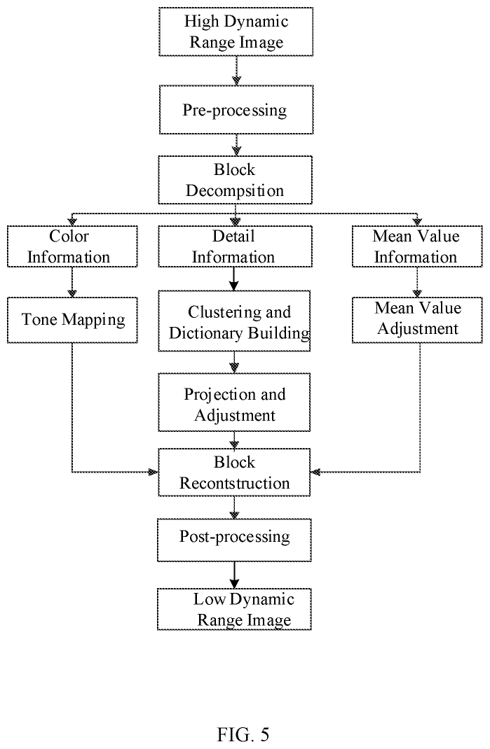

In accordance with the disclosure, there is provided an image processing method. FIG. 5 is a flowchart of an image processing method according to another embodiment of the disclosure. As shown in FIG. 5, the method can include pre-processing the high dynamic range image, which can be the original image in S101, and the pre-processing is the same as the process at S101. Block decomposition is implemented on the preprocessed high dynamic range image, the process of decomposition is consistent with the process at S102, where the blocks correspond to the first sub-images in the embodiments above. After decomposition, the detail information, color information, and mean value information of each block is obtained. The color information is color-adjusted. For example, the color information is nonlinearly compressed, e.g., according to the process at S404 to obtain the second compression data w₃(m̅ᵢ̅). Clustering and dictionary building are performed for the detail information, e.g., according to the processes at S401 and S402. The detail information is further projected and adjusted, e.g., according to the processes at S402 and S403. The mean value information is adjusted, e.g., according to the process at S405. Block reconstruction is performed on w₃(m̅ᵢ̅) obtained after color adjustment of the color information, P₁^{T}α obtained after projection and adjustment of the detail information, and w₂*m obtained after the mean value adjustment of the mean value information, and the result of the block reconstruction is shown above in formula (10), i.e., yᵢ=P₁^{T}α+w₂*m+w₃(m̅ᵢ̅). In some embodiments, post processing can be performed on yᵢ=P₁^{T}α+w₂*m+w₃(m̅ᵢ̅), where the post processes can include at least one of weighting process, pixel value adjustment, or pixel value mapping. The weighting process, pixel value adjustment, pixel value mapping, etc., are the same as the processes described above, which will not be described in detail here. The obtained final low dynamic range image is the target image described in the embodiments above.

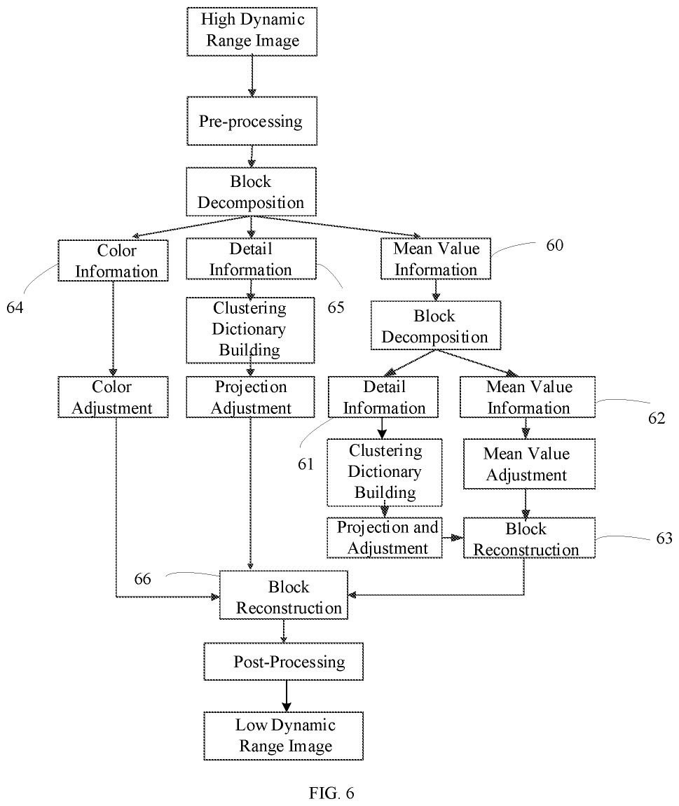

FIG. 6 is a flowchart of an image processing method according to another embodiment of the disclosure. The method shown in FIG. 6 is based on the method shown in FIG. 5 and further includes the following processes. the mean value information 60 obtained by the first block decomposition is further block decomposed to obtain detail information 61 and mean value information 62. The clustering and dictionary building processes performed on the detail information 61 obtained by the further block decomposition and the projection and adjustment processes are the same as those described above. The mean value adjustment process performed on the mean value information 62 obtained by the further decomposition is also the same as that described above. One block reconstruction 63 is performed on the results of performing clustering and dictionary building, as well as projection and adjustment, on the detail information 61, and the results of performing the mean value adjustment on the mean value information 62. Another block reconstruction 66 is performed on the results of performing color adjustment on the color information 64, the results of performing clustering and dictionary building, as well as projection and adjustment, on the detail information 65, and the results of the block reconstruction 63. In some embodiments, post processing can be performed on the results of the block reconstruction 66. The post processes include the weighting process, the pixel value adjustment, the pixel value mapping, etc. The weighting process, the pixel value adjustment, the pixel value mapping, etc., are the same as described above, which are not described here in detail. The obtained final low dynamic range image is the target image described above.

In the embodiment, the original image is pre-processed to obtain the first image, the first image is decomposed into the plurality of first sub-images, and the first sub-images are compressed according to the detail information, the color information, and the mean value information of the first sub-images to generate the plurality of second sub-images. The target image is determined according to the plurality of second sub-images. When the high dynamic range image is tone mapped, not only the tone mapping is performed on the brightness information, but also the detail information, the color information, and the mean value information are compressed at the same time to ensure that the low dynamic range image retains the color information of the high dynamic range image to avoid an offset in color of the low dynamic range image as compared to the high dynamic range image.

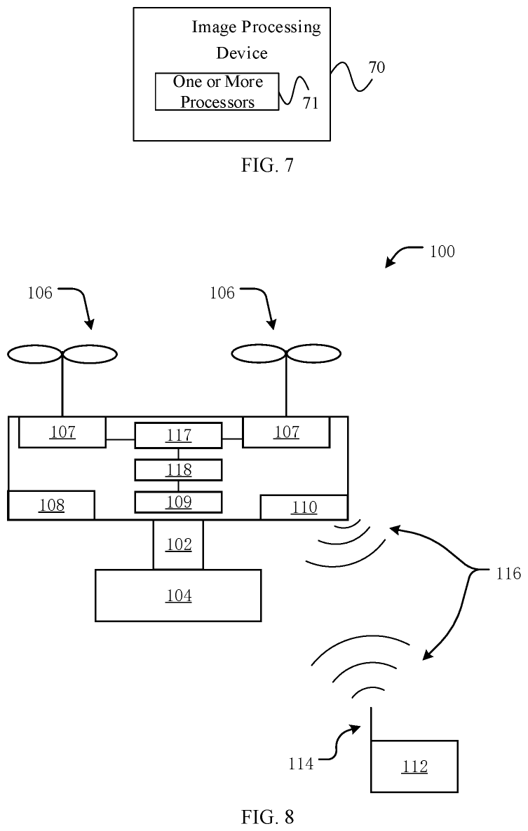

In accordance with the disclosure, there is provided an image processing device. FIG. 7 is a structure diagram of an example image processing device consistent with the embodiments of the disclosure. As shown in FIG. 7, the image processing device 70 includes one or more processors 71. The one or more processors 71 are, individually or collectively, configured to pre-process the original image to obtain the first image, decompose the first image into the plurality of first sub-images, determine the detail information, the color information, and the mean value information of the first sub-images, compress the plurality of first sub-images according to the detail information, the color information, and the mean value information to generate the plurality of second sub-images, and determine the target image according to the plurality of second sub-images.

In some embodiments, to compress the plurality of first sub-images according to the detail information, the color information, and the mean value information to generate the plurality of second sub-images, the one or more processors 71 non-linearly compress the color information and the detail information of the first sub-images and linearly compress the mean value information of the first sub-images to obtain the second sub-images.

In some embodiments, the original image is the high dynamic range image, the target image is the low dynamic range image.

In some embodiments, to pre-process the original image to obtain the first image, the one or more processors 71 convert the original image into RGB space to obtain the second image, and globally adjust the second image to obtain the first image. The first image includes the R channel data, the G channel data, and the B channel data.

In some embodiments, to determine the target image according to the plurality of second sub-images, the one or more processors 71 arrange the second sub-images corresponding to the first sub-images to construct the third image according to the positions of the first sub-images, and map the pixel values of the pixels of the third image into the dynamic range of the display device to obtain the target image.

In some embodiments, before the one or more processors 71 map the pixel values of the pixels of the third image into the dynamic range of the display device, the one or more processors 71 also adjust the pixel values of the pixels of the third image to improve the contrast of the third image.

The principles and implementation of the image processing device are similar to those of the methods described above in connection with FIG. 1, which are thus not described in detail here.

In the embodiment, the original image is pre-processed to obtain the first image, the first image is decomposed into the plurality of first sub-images, the first sub-images are compressed according to the detail information, the color information, and the mean value information of each first sub-image to generate the plurality of second sub-images, and the target image is determined according to the plurality of second sub-images. When the high dynamic range image is tone mapped, not only the tone mapping is performed on the brightness information, but also the detail information, the color information, and the mean value information are compressed at the same time to ensure that the low dynamic range image retains the color information of the high dynamic range image to avoid an offset in color of the low dynamic range image as compared to the high dynamic range image.

In accordance with the disclosure, there is provided an image processing device. Based on the technical solution of the embodiment descried above in connection with FIG. 7, to determine the detail information, the color information, and the mean value information of the first sub-images, the one or more processors 71 calculate the individual mean values of the first sub-images in R channel, G channel, and B channel, and determine the detail information, the color information, and the mean value information of the first sub-images.

In some embodiments, to determine the detail information, the color information, and the mean value information of the first sub-images according to the individual mean value of the first sub-images in R channel, G channel, and B channel, the one or more processors 71 determine the detail information of the first sub-images in R channel, G channel, and B channel according to the R channel data, the G channel data, and the B channel data of the first sub-images and the individual mean values of the first sub-images in R channel, G channel, and B channel, and determine the color information of the first sub-images in each channel according to the individual mean values of the first sub-images in R channel, G channel, and B channel and the mean value information of the first sub-images.

To calculate the individual mean values of the first sub-images in R channel, G channel, and B channel, the one or more processors 71 calculate the first mean value of the first sub-images in R channel according to the R channel data of the first sub-images, calculate the second mean value of the first sub-images in G channel according to the G channel data of the first sub-images, and calculate the third mean value of the first sub-images in B channel according to the B channel data of the first sub-images.

To determine the detail information of the first sub-images in R channel, G channel, and B channel according to R channel data, G channel data, and B channel data of the first sub-images and the individual mean values of the first sub-images in R channel, G channel, and B channel, the one or more processors 71 determine the detail information of the first sub-images in R channel according to the first mean value of the first sub-images in R channel, determine the detail information of the first sub-images in G channel according to the second mean value of the first sub-images in G channel, and determine the detail information of the first sub-images in B channel according to the third mean value of the first sub-images in B channel.

To determine the color information of the first sub-images in R channel, G channel, and B channel according to the individual mean values of the first sub-images in R channel, G channel, and B channel and the mean value information of the first sub-images, the one or more processors 71 determine the color information of the first sub-images in R channel according to the first mean value and the mean value information of the first sub-images, determine the color information of the first sub-images in G channel according to the second mean value and the mean value information of the first sub-images, and determine the color information of the first sub-images in B channel according to the third mean value and the mean value information of the first sub-images.

In some embodiments, the mean value information of the first sub-images is the mean value of the first mean value, the second mean value, and the third mean value.

The principles and implementation of the image processing device are similar to those of the methods described above in connection with FIG. 3, which are thus not described here in detail.

In the embodiment, by calculating the individual mean values of the first sub-images in R channel, G channel, and B channel, the detail information, the color information, and the mean value information of the first sub-images are determined and the accurate calculations are implemented for the detail information, the color information, and the mean value information.

In accordance with the disclosure, there is provided an image processing device. Based on the technical solution of the embodiments descried above in connection with FIG. 7, to non-linearly compress the color information and the detail information of the first sub-images and the mean value information of the first sub-images is linearly compressed to obtain the second sub-images, the one or more processors 71 to project the first sub-images according to the detail information and the groups to which the first sub-images belongs to obtain the projection value of the detail information of the first sub-images, non-linearly compress the projection value of the detail information of the first sub-images to obtain the first compression data, non-linearly compress the color information of the first sub-images to obtain the second compression value, linearly compress the mean value of the first sub-images to obtain the third compression data, and reconstruct the image according to the first compression data, the second compression data, and the third compression data to obtain the second sub-images.

In some embodiments, before the first sub-images are projected according to the detail information and the groups to which the first sub-images belong, the one or more processors 71 cluster the detail information of the first sub-images to determine the groups to which the first sub-images belong.

In some embodiments, to project the first sub-images according to the detail information and the groups to which the first sub-images belong, the one or more processors 71 determine the covariance matrices of the groups to which the first sub-images belong, decompose the covariance matrices to determine the corresponding dictionaries of the groups to which the first sub-images belong, and project the detail information of the first sub-images in the corresponding dictionaries of the groups to which the first sub-images belong.

The principles and implementation of the image processing device are similar to those of the methods described above in connection with FIG. 4, which are thus not described here in detail.

In the embodiment, the original image is pre-processed to obtain the first image, the first image is decomposed into the plurality of first sub-images, and the first sub-images are compressed according to the detail information, the color information, and the mean value information of the first sub-images to generate the plurality of second sub-images. The target image is determined according to the plurality of second sub-images. When the tone mapping is performed on the high dynamic range image, not only the tone mapping is performed on the brightness information, but also the detail information, the color information, and the mean value information are compressed at the same time to ensure that the low dynamic range image retains the color information of the high dynamic range image to avoid an offset in color of the low dynamic range image as compared to the high dynamic range image.

In accordance with the disclosure, there is provided an unmanned aerial vehicle (UAV). FIG. 8 is a structure diagram of an example UAV consistent with the embodiments of the disclosure. As shown in FIG. 8, the UAV 100 includes a body, a power system, a flight controller 118, or an image processing device 109. The power system may include at least one of an electrical motor 107, a propeller 106, or an electronic governor 117. The power system is installed at the body configured to provide flying power, and the flight controller 118 that is communicatively connected to the power system is configured to control the flight of the UAV.

In some embodiments, as shown in FIG. 8, the UAV 100 also includes a sensor system 108, a communication system 110, a carrier 102, or a photographing device 104. The carrier 102 can specifically be a gimbal. The communication system 110 includes a receiver, and the receiver is configured to receive a wireless signal sent by an antenna 114 at a ground station 112. Reference numeral 116 indicates an electromagnetic wave, which is generated during the communication between the receiver and the antenna 114.

The image processing device 109 can perform image processing to the image captured by the photographing device 104. The image processing method is similar to those of the methods described above, the principles and the implementation of image processing device 109 are similar to those of the methods described above, which are thus not described here in detail.

In the embodiment, the original image is pre-processed to obtain the first image, the first image is decomposed into the plurality of first sub-images, and the first sub-images are compressed to generate the plurality of second sub-images according to the detail information, the color information, and the mean value information of the first sub-images. The target image is determined according to the plurality of second sub-images. When the tone mapping is performed on the high dynamic range image, not only the tone mapping is performed on the brightness information, but also the detail information, the color information, and the mean value information are compressed at the same time to ensure that the low dynamic range image retains the color information of the high dynamic range image to avoid an offset in color of the low dynamic range image as compared to the high dynamic range image.

In accordance with the disclosure, there is provided a computer-readable storage medium, in which the computer program is stored. The computer program is executed by the one or more processors to pre-process the original image to obtain the first image, decompose the first image into the plurality of first sub-images, determine the detail information, the color information, and the mean value information of the first sub-images, compress the plurality of first sub-images to generate the plurality of second sub-images according to the detail information, the color information, and the mean value information, and determine the target image according to the plurality of second sub-images.

In some embodiments, the plurality of first sub-images are compressed to generate the plurality of second sub-images according to the detail information, the color information, and the mean value information, and the process includes non-linearly compressing the color information and the detail information of each first sub-image and linearly compressing the mean value information of the first sub-images to obtain the second sub-images.

In some embodiments, the original image is the high dynamic range image, and the target image is the low dynamic range image.

In some embodiments, pre-processing the original image to obtain the first image includes converting the original image into RGB space to obtain the second image, and globally adjusting the second image to obtain the first image. The first image includes the R channel data, the G channel data, or the B channel data.

In some embodiments, determining the detail information, the color information, and the mean value information of the first sub-images includes calculating the individual mean values of the first sub-images in R channel, G channel, and B channel, and determining the detail information, the color information, and the mean value information of the first sub-images according to the individual mean values of the first sub-images in R channel, G channel, and B channel.

In some embodiments, determining the detail information, the color information, and the mean value information of the first sub-images according to the individual mean values of the first sub-images in R channel, G channel, and B channel includes determining the detail information of the first sub-images in R channel, G channel, and B channel according to the R channel data, the G channel data, and the B channel data and the individual mean values of the first sub-images in R channel, G channel, and B channel, and determining the color information of the first sub-images in R channel, G channel, and B channel according to the individual mean values of the first sub-images in R channel, G channel, and B channel and the mean value information of the first sub-images.

In some embodiments, calculating the individual mean values of the first sub-images in R channel, G channel, and B channel includes calculating the first mean value of the first sub-images in R channel according to the R channel data of the first sub-images, calculating the second mean value of the first sub-images in G channel according to the G channel data of the first sub-images, and calculating the third mean value of the first sub-images in B channel according to the B channel data of the first sub-images.

In some embodiments, determining the detail information of the first sub-images in R channel, G channel, or B channel according to the R channel data, the G channel data, and the B channel data of the first sub-image and the individual mean values of the first sub-images in R channel, G channel, and B channel includes determining the detail information of the first sub-images in R channel according to the R channel data of the first sub-images and the first mean value, determining the detail information of the first sub-images in G channel according to the G channel data of the first sub-images and the second mean value, and determining the detail information of the first sub-images in B channel according to the B channel data of the first sub-images and the third mean value.

In some embodiments, according to the individual mean values of the first sub-images in R channel, G channel, and B channel and the mean value information of the first sub-images, determining the color information of the first sun-images in R channel, G channel, and B channel includes determining the color information of the first sub-images in R channel according to the first mean value and the mean value information of the first sub-images, determining the color information of the first sub-images in G channel according to the second mean value and the mean value information of the first sub-images, and determining the color information of the first sub-images in B channel according to the third mean value and the mean value information of the first sub-images.

In some embodiments, the mean value information of the first sub-images is the mean value of the first mean value, the second mean value, and the third mean value.

In some embodiments, non-linearly compressing the color information and the detail information of the first sub-images and linearly compressing the mean value information of the first sub-images to obtain the second sub-images includes projecting the first sub-images according to the detail information of the first sub-images and the groups to which the first sub-images belong to obtain the projection value of the detail information of the first sub-images, non-linearly compressing the projection value of the detail information of the first sub-images to obtain the first compression data, non-linearly compressing the color information of the first sub-images to obtain the second compression data, linearly compressing the mean value information of the first sub-images to obtain the third compression data, and reconstructing the image according to the first compression data, the second compression data, and the third compression data to obtain the second image.

In some embodiments, before projecting the first sub-images according to the detail information of the first sub-images and the groups to which the first sub-images belong includes clustering the detail information of the first images to determine the groups to which the first sub-images belong.

In some embodiments, projecting the first sub-images according to the detail information of the first sub-images and the groups to which the first sub-images belong includes determining covariance matrices of the groups to which the first sub-images belong, decomposing the covariance matrices to determine the corresponding dictionaries of the groups to which the first images belong, and projecting the detail information of the first sub-images into the corresponding dictionaries of the groups to which the first sub-images belong.

In some embodiments, determining the target image according to a plurality of second images includes arranging the corresponding second sub-images of the first sub-images according to the positions of the sub-images in the first image to construct the third image, and mapping the pixel values of the pixels of the third images into the dynamic range of the display device to obtain the target image.

In some embodiments, before projecting the pixel values of the pixels in the third image into the dynamic range of the display device includes adjusting the pixel values of the pixels of the third image to improve the contrast of the third image.

In some embodiments of the disclosure, the devices and methods disclosed can be implemented in other forms. For example, the device embodiments described above are merely illustrative. the division of the units is only a logical function division, and the actual implementation may be according to another division method. For example, a plurality of units or components can be combined or integrated in another system, or some features can be omitted or not be executed. Further, the displayed or discussed mutual coupling or direct coupling or communicative connection can be through some interfaces, the indirect coupling or communicative connection of the devices or units can be electronically, mechanically, or in other forms.

The units described as separate instructions may be or may not be physically separated, the components displayed as units may be or may not be physical units, which can be in one place or be distributed to a plurality of network units. Some or all of the units can be chosen to implement the purpose of the embodiment according to the actual needs.

In the embodiments of the disclosure, individual functional units can be integrated in one processing unit, or can be individual units physically separated, or two or more units can be integrated in one unit. The integrated units above can be implemented by hardware or can be implemented by hardware and software functional unit.

The integrated units implemented by software functional units can be stored in a computer-readable storage medium. The above software functional units stored in a storage medium includes a plurality of instructions for a computing device (such as a personal computer, a server, or network device, etc.) or a processor to execute some of the operations in the embodiments of the disclosure. The storage medium includes USB drive, mobile hard disk, read-only memory (ROM), random access memory (RAM), disk or optical disk, or another medium that can store program codes.

Those of ordinary skilled in the art can understand that, for convenient and simple description, the division of individual functional units are described as an example. In actual applications, the functions above can be assigned to different functional units for implementation, i.e., the internal structure of the device can be divided into different functional units to implement all or some of the functions described above. For the specific operation process of the device described above, reference can be to the corresponding process in the method embodiments, which will not be described in detail here.

The individual embodiments are merely used to describe the technical solution of the disclosure but not used to limit the disclosure. Although the disclosure is described in detail referring to the individual embodiments, one of ordinary skill in the art should understand that it is still possible to modify the technical solutions in the embodiments, or to replace some or all of the technical features. However, these modifications or substitutions do not cause the essence of the corresponding technical solution to depart from the scope of the technical solutions in the individual embodiments of the disclosure.

What is claimed is:

1. An image processing method comprising:
pre-processing an original image to obtain a pre-processed image;
decomposing the pre-processed image to obtain a plurality of first sub-images;
determining detail information, color information, and mean value information of each of the plurality of first sub-images;
compressing the plurality of first sub-images according to the detail information, the color information, and the mean value information of the plurality of first sub-images to obtain a plurality of second sub-images; and
determining a target image according to the plurality of second sub-images.

2. The method of claim 1, wherein:
the original image is a high dynamic range image, and the target image is a low dynamic range image; and
compressing the plurality of first sub-images to obtain the plurality of second sub-images includes, for each of the plurality of first sub-images, non-linearly compressing the color information and the detail information of the first sub-image and linearly compressing the mean value information of the first sub-image to obtain the corresponding second sub-image.

3. The method of claim 2, wherein non-linearly compressing the color information and the detail information of the first sub-image and linearly compressing the mean value information of the first sub-image to obtain the corresponding second sub-image includes:
projecting the first sub-image according to the detail information of the first sub-image and a group to which the first sub-image belongs, to obtain a projection value of the detail information of the first sub-image;
non-linearly compressing the projection value of the detail information of the first sub-image to obtain first compression data;
non-linearly compressing the color information of the first sub-image to obtain second compression data;
linearly compressing the mean value information of the first sub-image to obtain third compression data; and
performing image reconstruction according to the first compression data, the second compression data, and the third compression data to obtain the corresponding second sub-image.

4. The method of claim 3, wherein projecting the first sub-image includes:
determining a covariance matrix of the group to which the first sub-image belongs;
decomposing the covariance matrix to determine a corresponding dictionary of the group to which the first sub-image belongs; and
projecting the detail information of the first sub-image into the corresponding dictionary.

5. The method of claim 1, wherein:
pre-processing the original image to obtain the pre-processed image includes:
converting the original image into RGB space to obtain an RGB image; and
globally adjusting the RGB image to obtain the pre-processed image, the pre-processed image including R channel data, G channel data, and B channel data; and
determining the detail information, the color information, and the mean value information of each of the plurality of first sub-images includes, for each of the plurality of first sub-images:
calculating mean values of the first sub-image in an R channel, a G channel, and a B channel, respectively; and
determining the detail information, the color information, and the mean value information of the first sub-image according to the mean values of the first sub-image.

6. The method of claim 5, wherein determining the detail information, the color information, and the mean value information of the first sub-image according to the mean values of the first sub-image includes:
determining detail information of the first sub-image in each of the R channel, the G channel, and the B channel according to R channel data, G channel data, and B channel data of the first sub-image and the mean values of the first sub-image; and
determining color information of the first sub-image in each of the R channel, the G channel, and the B channel according to the mean value information of the first sub-image and the mean values of the first sub-image.

7. The method of claim 6, wherein calculating the mean values of the first sub-image includes:
calculating a first mean value of the first sub-image in the R channel according to R channel data of the first sub-image;
calculating a second mean value of the first sub-image in the G channel according to G channel data of the first sub-image; and
calculating a third mean value of the first sub-image in the B channel according to B channel data of the first sub-image.

8. The method of claim 7, wherein determining the detail information of the first sub-image in each of the R channel, the G channel, and the B channel according to the R channel data, the G channel data, and the B channel data of the first sub-image and the mean values of the first sub-image includes:
determining the detail information of the first sub-image in the R channel according to the R channel data of the first sub-image and the first mean value;
determining the detail information of the first sub-image in the G channel according to the G channel data of the first sub-image and the second mean value; and
determining the detail information of the first sub-image in the B channel according to the B channel data of the first sub-image and the third mean value.

9. The method of claim 8, wherein,
the mean value information of the first sub-image includes an overall mean value of the first mean value, the second mean value, and the third mean value; and
determining the color information of the first sub-image in each of the R channel, the G channel, and the B channel according to the mean value information of the first sub-image and the mean values of the first sub-image includes:
determining the color information of the first sub-image in the R channel according to the first mean value and the mean value information of the first sub-image;
determining the color information of the first sub-image in the G channel according to the second mean value and the mean value information of the first sub-image; and
determining the color information of the first sub-image in the B channel according to the third mean value and the mean value information of the first sub-image.

10. The method of claim 1, wherein determining the target image includes:
arranging the second sub-images according to positions of the first sub-images in the pre-processed image to construct a composed image;
adjusting pixel values of pixels of the composed image to improve a contrast of the composed image; and
projecting the pixel values of the pixels of the composed image into a dynamic range of a display device to obtain the target image.

11. An image processing device comprising:
a computer-readable storage medium storing a computer program; and
one or more processors individually or collectively configured to execute the computer program to:
pre-process an original image to obtain a pre-processed image;
decompose the pre-processed image to obtain a plurality of first sub-images;
determine detail information, color information, and mean value information of each of the plurality of first sub-images;
compress the plurality of first sub-images according to the detail information, the color information, and the mean value information of the plurality of first sub-images to obtain a plurality of second sub-images; and
determine a target image according to the plurality of second sub-images.

12. The device of claim 11, wherein:
the original image is a high dynamic range image, and the target image is a low dynamic range image; and
the one or more processors are further configured to execute the computer program to compress the plurality of first sub-images to obtain the plurality of second sub-images by, for each of the plurality of first sub-images, non-linearly compressing the color information and the detail information of the first sub-image and linearly compressing the mean value information of the first sub-image to obtain the corresponding second sub-image.

13. The device of claim 12, wherein the one or more processors are further configured to execute the computer program to non-linearly compress the color information and the detail information of the first sub-image and linearly compress the mean value information of the first sub-image to obtain the corresponding second sub-image by:
projecting the first sub-image according to the detail information of the first sub-image and a group to which the first sub-image belongs, to obtain a projection value of the detail information of the first sub-image;
non-linearly compressing the projection value of the detail information of the first sub-image to obtain first compression data;
non-linearly compressing the color information of the first sub-image to obtain second compression data;
linearly compressing the mean value information of the first sub-image to obtain third compression data; and
performing image reconstruction according to the first compression data, the second compression data, and the third compression data to obtain the corresponding second sub-image.

14. The device of claim 13, wherein the one or more processors are further configured to execute the computer program to project the first sub-image by:
determining a covariance matrix of the group to which the first sub-image belongs;
decomposing the covariance matrix to determine a corresponding dictionary of the group to which the first sub-image belongs; and
projecting the detail information of the first sub-image into the corresponding dictionary.

15. The device of claim 11, wherein the one or more processors are further configured to execute the computer program to:
pre-process the original image to obtain the pre-processed image by:
converting the original image into RGB space to obtain an RGB image; and
globally adjusting the RGB image to obtain the pre-processed image, the pre-processed image including R channel data, G channel data, and B channel data; and
determine the detail information, the color information, and the mean value information of each of the plurality of first sub-images by, for each of the plurality of first sub-images:
calculating mean values of the first sub-image in an R channel, a G channel, and a B channel, respectively; and
determining the detail information, the color information, and the mean value information of the first sub-image according to the mean values of the first sub-image.

16. The device of claim 15, wherein the one or more processors are further configured to execute the computer program to determine the detail information, the color information, and the mean value information of the first sub-image according to the mean values of the first sub-image by:
determining detail information of the first sub-image in each of the R channel, the G channel, and the B channel according to R channel data, G channel data, and B channel data of the first sub-image and the mean values of the first sub-image; and
determining color information of the first sub-image in each of the R channel, the G channel, and the B channel according to the mean value information of the first sub-image and the mean values of the first sub-image.

17. The device of claim 16, wherein the one or more processors are further configured to execute the computer program to calculate the mean values of the first sub-image by:
calculating a first mean value of the first sub-image in the R channel according to R channel data of the first sub-image;
calculating a second mean value of the first sub-image in the G channel according to G channel data of the first sub-image; and
calculating a third mean value of the first sub-image in the B channel according to B channel data of the first sub-image.

18. The device of claim 17, wherein the one or more processors are further configured to execute the computer program to determine the detail information of the first sub-image in each of the R channel, the G channel, and the B channel according to the R channel data, the G channel data, and the B channel data of the first sub-image and the mean values of the first sub-image by:
determining the detail information of the first sub-image in the R channel according to the R channel data of the first sub-image and the first mean value;
determining the detail information of the first sub-image in the G channel according to the G channel data of the first sub-image and the second mean value; and
determining the detail information of the first sub-image in the B channel according to the B channel data of the first sub-image and the third mean value.

19. The device of claim 18, wherein,
the mean value information of the first sub-image includes an overall mean value of the first mean value, the second mean value, and the third mean value; and
the one or more processors are further configured to execute the computer program to determine the color information of the first sub-image in each of the R channel, the G channel, and the B channel according to the mean value information of the first sub-image and the mean values of the first sub-image by:
determining the color information of the first sub-image in the R channel according to the first mean value and the mean value information of the first sub-image;
determining the color information of the first sub-image in the G channel according to the second mean value and the mean value information of the first sub-image; and
determining the color information of the first sub-image in the B channel according to the third mean value and the mean value information of the first sub-image.

20. The device of claim 11, wherein the one or more processors are further configured to execute the computer program to determine the target image by:
arranging the second sub-images according to positions of the first sub-images in the pre-processed image to construct a composed image;
adjusting pixel values of pixels of the composed image to improve a contrast of the composed image; and
projecting the pixel values of the pixels of the composed image into a dynamic range of a display device to obtain the target image.
